(19) United States
(12) Patent Application Publication
(10) Pub. No.: US 2026/0344637 A1
(43) Pub. Date: Nov. 5, 2026

(54) FISHING WEIGHT SINKER WITH IMPROVED LIFT CHARACTERISTICS

(71) Applicants: Yevhen Voitiuk, Agoura Hills, CA (US); Kostiantyn Voitiuk, Agora Hills, CA (US)

(72) Inventors: Yevhen Voitiuk, Agoura Hills, CA (US); Kostiantyn Voitiuk, Agora Hills, CA (US)

(21) Appl. No.: 19/194,149

(22) Filed: Apr. 30, 2025

(51) Int. Cl. A01K 95/00

(52) U.S. Cl. CPC A01K 95/00

(57) ABSTRACT

A fishing weight sinker may comprise a body having a generally dome-shaped configuration. The body may be configured to provide improved lift characteristics when submerged in water. The body may have a smooth, reflective surface. The body may be made of a dense material. The dense material may be lead. The fishing weight sinker may further comprise a plastic portion attached to the body to enhance floating capabilities. The body may have a width-to-height ratio between 2:1 and 5:1. The body may have a weight between 0.1 ounces and 7 ounces. A method of manufacturing the fishing weight sinker may comprise forming the body having the generally dome-shaped configuration. A fishing system may comprise a fishing line, a fishing hook attached to the fishing line, and the fishing weight sinker attached to the fishing line. The fishing weight sinker may be attached to the fishing line via a swivel clip.

### FIELD OF THE INVENTION

The present disclosure relates generally to fishing equipment, and more particularly to fishing weight sinkers with improved lift characteristics.

### BACKGROUND

Fishing weight sinkers are commonly used in various fishing applications to add weight to fishing lines, allowing bait or lures to sink to desired depths. Traditional weight sinkers often have shapes that can easily become snagged on underwater obstacles such as rocks, vegetation, or debris. This can lead to line breakage, loss of equipment, and environmental concerns due to lead deposits in water bodies.

There is a need for improved fishing weight sinkers that can more easily lift from the bottom of water bodies, reducing the likelihood of snagging and associated problems.

### BRIEF OVERVIEW

The present disclosure provides various embodiments of fishing weight sinkers with improved lift characteristics. In some embodiments, a fishing weight sinker may have a unique “reverse-bubble” or “UFO” shape that enables it to lift more easily from the bottom of a body of water compared to traditional shapes.

It should be appreciated that this brief overview is provided to introduce a selection of concepts in a simplified form that are further described below in the detailed description. This brief overview is not intended to identify key features or essential features of the claimed subject matter, nor is it intended to be used as an aid in determining the scope of the claimed subject matter. Further, the claimed subject matter is not limited to implementations that solve any or all disadvantages noted in any part of this disclosure.

### BRIEF DESCRIPTION OF THE DRAWINGS

The accompanying drawings, which are incorporated in and constitute a part of this specification, illustrate various embodiments and together with the description, serve to explain the principles of the disclosed embodiments.

FIG. 1 is a perspective view of multiple fishing weight sinkers according to some embodiments.

FIG. 2 is a close-up view of a fishing weight sinker according to some embodiments.

FIG. 3 is another view of a fishing weight sinker according to some embodiments.

FIG. 4 is a perspective view of multiple fishing weight sinkers according to some embodiments.

FIG. 5 is a schematic diagram illustrating dimensions and weight ranges of fishing weight sinkers according to some embodiments.

FIG. 6 is a view of a fishing weight sinker attached to a fishing line according to some embodiments.

FIG. 7 is a detailed view of a surface of a fishing weight sinker according to some embodiments.

### DETAILED DESCRIPTION

The following detailed description refers to the accompanying drawings. Wherever possible, the same reference numbers are used in the drawings and the following description to refer to the same or similar elements. While various embodiments may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the scope of the claims. Instead, the proper scope is defined by the appended claims.

Embodiments of the present disclosure provide fishing weight sinkers with improved lift characteristics. These weight sinkers may have a unique shape that allows them to lift more easily from the bottom of a body of water, reducing the likelihood of snagging on underwater obstacles.

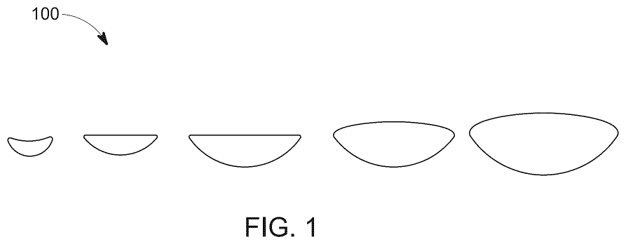

Referring now to FIG. 1, a perspective view of multiple fishing weight sinkers 100 according to some embodiments is shown. The weight sinkers 100 may have a generally dome-shaped or “reverse-bubble” configuration. This shape may contribute to the improved lift characteristics of the weight sinkers.

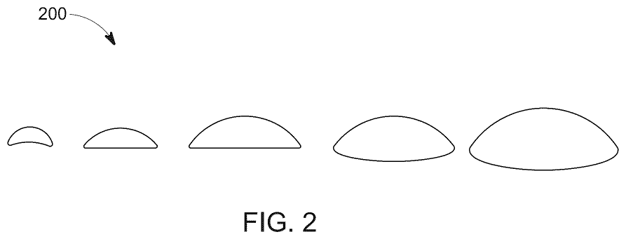

FIG. 2 provides a close-up view of a fishing weight sinker 200 according to some embodiments. The weight sinker 200 may have a smooth, reflective surface that may reduce friction with water and underwater obstacles.

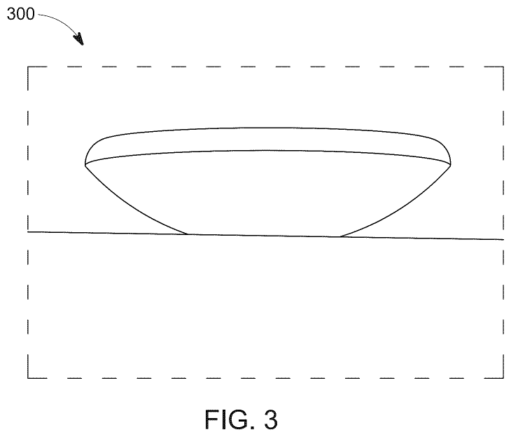

FIG. 3 illustrates another view of a fishing weight sinker 300 according to some embodiments. The rounded shape of the weight sinker 300 may facilitate its movement through water and its ability to lift from the bottom of a water body.

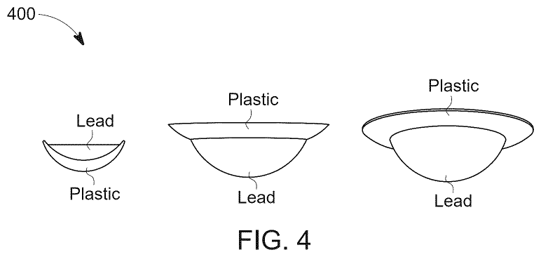

Turning to FIG. 4, a perspective view of multiple fishing weight sinkers 400 is shown. The weight sinkers 400 may be manufactured in various sizes to accommodate different fishing needs and conditions.

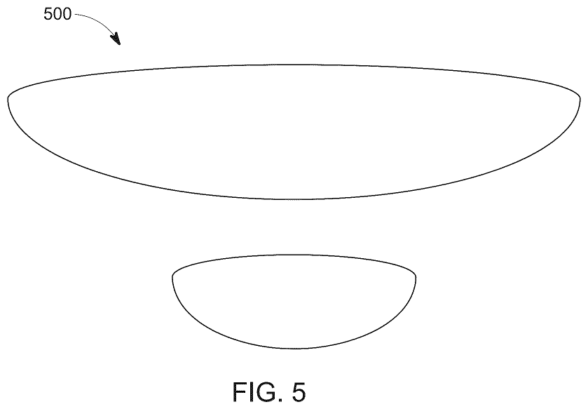

FIG. 5 is a schematic diagram illustrating dimensions and weight ranges of fishing weight sinkers according to some embodiments. A larger weight sinker may have a width of 11 units, a height of 2.4 units, and a weight range of 0.7 to 7 ounces, with a ratio of 4.6/1. A smaller weight sinker may have a width of 7 units, a height of 3.2 units, and a weight range of 0 to 0.7 ounces, with a ratio of 2.2/1. These dimensions and weight ranges are provided as examples and may vary in different embodiments.

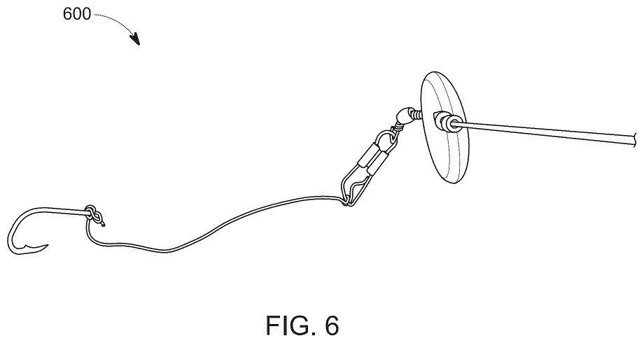

FIG. 6 shows a fishing weight sinker 600 attached to a fishing line according to some embodiments. The weight sinker 600 may be connected to the fishing line via a swivel clip, allowing for smooth movement and rotation of the weight sinker in water.

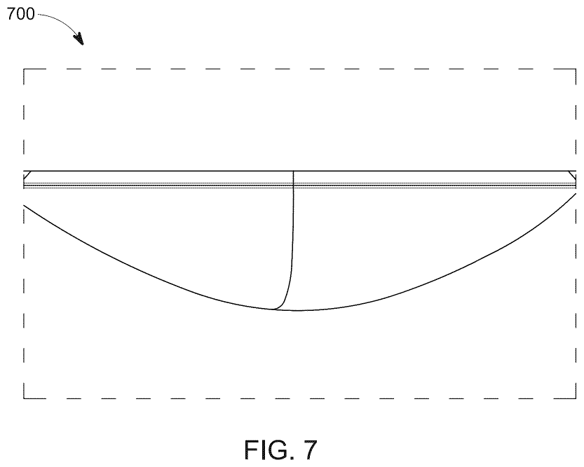

FIG. 7 provides a detailed view of a surface of a fishing weight sinker 700 according to some embodiments. The surface may have small, scattered particles that create a textured look, which may affect the hydrodynamic properties of the weight sinker.

The fishing weight sinkers described herein may be made of various materials, including but not limited to lead or other dense materials. In some embodiments, the weight sinkers may be combined with a “parachute” plastic portion to enhance their floating capabilities. The unique shape of the fishing weight sinkers described herein may provide several advantages. For example, the weight sinkers may lift up from the bottom of a body of water more easily than traditional shapes, reducing the likelihood of getting stuck on debris, rocks, or vegetation. This may result in reduced line breakage and loss of weight sinkers, decreased lead deposits in water bodies, less time spent re-gearing and fixing fishing rods, and an overall improved fishing experience.

In use, a fisher may attach the fishing weight sinker to a fishing line, cast the line into the water, and allow the weight to sink to the bottom. When reeling in or moving the line, the fisher may experience less resistance and snagging, and may be able to retrieve the weight more easily from the bottom. This may result in less time dealing with snags or re-rigging, allowing for a more continuous and enjoyable fishing activity.

The fishing weight sinkers described herein may be used in various aquatic environments, including but not limited to lakes, rivers, and oceans. They may be particularly useful in areas with rocky or vegetated bottoms where traditional weight sinkers are prone to snagging.

The fishing weight sinkers described herein may be manufactured using various methods and materials. In some embodiments, the weight sinkers may be formed through a casting process. Molten lead or another dense material may be poured into molds shaped to create the dome-shaped or “reverse-bubble” configuration of the weight sinkers. The molds may be designed to produce weight sinkers of various sizes and weight ranges.

In other embodiments, the weight sinkers may be formed through a stamping or pressing process. A sheet of lead or another suitable material may be fed into a stamping machine equipped with dies shaped to create the desired dome-shaped profile. The stamping process may allow for efficient production of multiple weight sinkers simultaneously.

The surface of the weight sinkers may be treated to achieve desired properties. In some embodiments, the weight sinkers may undergo a polishing process to create a smooth, reflective surface. This polishing may be accomplished through mechanical means, such as tumbling with abrasive materials, or through chemical processes.

In embodiments where the weight sinkers include a textured surface, as shown in FIG. 7, the texture may be created during the molding process by using molds with textured surfaces. Alternatively, the texture may be added after the initial forming process through methods such as etching, sandblasting, or application of a textured coating.

For embodiments that incorporate a plastic “parachute” portion, the plastic component may be molded separately and then attached to the metal weight sinker. The attachment may be accomplished through various means, such as adhesive bonding, mechanical fastening, or overmolding processes.

The weight sinkers may be produced in a range of sizes to accommodate different fishing needs. As illustrated in FIG. 5, larger weight sinkers may have different dimensional ratios compared to smaller weight sinkers. The manufacturing process may be adjusted to produce weight sinkers with specific dimensions and weight ranges.

In some embodiments, the weight sinkers may be coated with a protective layer to enhance durability and resistance to corrosion. This coating may be applied through processes such as powder coating, electroplating, or dip coating.

The attachment point for the fishing line, such as a hole or loop, may be incorporated into the weight sinker during the initial forming process or may be added as a secondary operation. In embodiments where a swivel clip is used, as shown in FIG. 6, the clip may be attached to the weight sinker after the main body has been formed.

Quality control measures may be implemented throughout the manufacturing process to ensure consistency in shape, weight, and surface finish of the weight sinkers. These measures may include visual inspections, weight checks, and dimensional measurements.

The manufacturing process may be designed to minimize waste and environmental impact. Excess material from the production process may be collected and recycled into new weight sinkers. Additionally, environmentally friendly alternatives to lead may be explored and incorporated into the manufacturing process where feasible.

It should be understood that the embodiments described herein are provided for illustrative purposes only and are not intended to limit the scope of the invention. Various modifications and variations can be made without departing from the spirit or scope of the invention. Other embodiments will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A fishing weight sinker comprising:
a body having a generally dome-shaped configuration,
wherein the body is configured to provide improved lift characteristics when submerged in water.

2. The fishing weight sinker of claim 1, wherein the body has a smooth, reflective surface.

3. The fishing weight sinker of claim 1, wherein the body is made of a dense material.

4. The fishing weight sinker of claim 3, wherein the dense material is lead.

5. The fishing weight sinker of claim 1, further comprising a plastic portion attached to the body to enhance floating capabilities.

6. The fishing weight sinker of claim 1, wherein the body has a width-to-height ratio between 2:1 and 5:1.

7. The fishing weight sinker of claim 1, wherein the body has a weight between 0.1 ounces and 7 ounces.

8. A method of manufacturing a fishing weight sinker, the method comprising:
forming a body having a generally dome-shaped configuration,
wherein the body is configured to provide improved lift characteristics when submerged in water.

9. The method of claim 8, further comprising forming the body with a smooth, reflective surface.

10. The method of claim 8, wherein forming the body comprises using a dense material.

11. The method of claim 10, wherein the dense material is lead.

12. The method of claim 8, further comprising attaching a plastic portion to the body to enhance floating capabilities.

13. The method of claim 8, wherein forming the body comprises creating a width-to-height ratio between 2:1 and 5:1.

14. The method of claim 8, wherein forming the body comprises creating a weight between 0.1 ounces and 7 ounces.

15. A fishing system comprising:
a fishing line;
a fishing hook attached to the fishing line; and
a fishing weight sinker attached to the fishing line,
wherein the fishing weight sinker comprises a body having a generally dome-shaped configuration,
wherein the body is configured to provide improved lift characteristics when submerged in water.

16. The fishing system of claim 15, wherein the fishing weight sinker is attached to the fishing line via a swivel clip.

17. The fishing system of claim 15, wherein the body of the fishing weight sinker has a smooth, reflective surface.

18. The fishing system of claim 15, wherein the body of the fishing weight sinker is made of a dense material.

19. The fishing system of claim 15, wherein the fishing weight sinker further comprises a plastic portion attached to the body to enhance floating capabilities.

20. The fishing system of claim 15, wherein the body of the fishing weight sinker has a width-to-height ratio between 2:1 and 5:1 and a weight between 0.1 ounces and 7 ounces.
